(19) United States
(12) Patent Application Publication
(10) Pub. No.: US 2020/0189772 A1
(43) Pub. Date: Jun. 18, 2020

(54) Scoop with Level

(71) Applicant: Adrian Rivera, (US)

(72) Inventors: Adrian Rivera, Whittier, CA (US); Kenneth L. Green, La Habra Heights, CA (US)

(21) Appl. No.: 16/679,132

(22) Filed: Nov. 8, 2019

Related U.S. Application Data
(63) Continuation-in-part of application No. 15/286,845, filed on Oct. 6, 2016, now abandoned.
Application No. 15/286,845 is a continuation-in-part of application No. 15/256,929, filed on Sep. 6, 2016, now abandoned.
Application No. 15/256,929 is a continuation-in-part of application No. 15/187,444, filed on Jun. 20, 2016, now Pat. No. 9,586,709.
Application No. 15/187,444 is a continuation-in-part of application No. 15/390,332, filed on Dec. 23, 2016.

(51) Int. Cl. B65B 1/24; B65B 29/02; B65D 85/804; B65B 67/02; A47J 31/06; G01F 19/00

(52) U.S. Cl. CPC B65B 1/24; B65B 29/022; G01F 19/002; B65B 67/02; A47J 31/0689; B65D 85/8043

(57) ABSTRACT

A scooping and leveling device includes a scoop arm, a scoop arranged at an end of the scoop arm, and a leveling element. The scoop has a concave interior and a planar rim. The leveling element has a leveling arm coupled to the scoop arm, and a leveling bar disposed at an end of the leveling arm. The leveling bar has the same size and shape as a portion of the rim of the scoop. The leveling arm is coupled to the scoop arm such that the leveling element is movable between a first position and a second position. In the first position, the leveling bar is disposed on the at least a portion of the rim of the scoop. In the second position, the first end of the leveling arm is disposed beyond a far end of the rim of the scoop.

### CROSS-REFERENCE TO RELATED APPLICATIONS

This is a continuation-in-part of co-pending U.S. patent application Ser. No. 15/390,332, which was filed on Dec. 23, 2016, which in turn is a continuation-in-part of U.S. patent application Ser. No. 15/187,444, which was filed on Jun. 20, 2016; which in turn is a continuation-in-part of U.S. patent application Ser. No. 15/256,929, which was filed on Sep. 6, 2016; and which in turn is a continuation-in-part of U.S. patent application Ser. No. 15/286,845 which was filed on Oct. 6, 2016, the entire disclosures of which applications are incorporated in their entirety herein by this reference.

### FIELD OF THE INVENTION

The invention relates to brewed beverages and in particular to implements used in the process of brewing beverages.

### BACKGROUND OF THE INVENTION

Brewed beverages are typically made by passing liquid through ground brewing material, or by steeping the brewing material in a liquid. For example, espresso beverages are typically made by forcing high-pressure water through tightly packed, finely ground coffee beans. The ground coffee is typically contained in a holder commonly called a portafilter, or in a pre-packaged espresso cartridge. High-pressure water is forced through the ground coffee and beverage is extracted in small, concentrated amounts. Many espresso drinkers prefer the simplicity of using the espresso cartridges, but are limited in the selection of ground coffee to varieties available in the pre-packaged espresso cartridges, and the cost of a single cartridge can be great compared to coffee that is ground and provided by a user.

Likewise, drinkers of conventional brewed coffee often prefer to select and grind coffee beans to produce brewing material from which to brew their coffee. Tea drinkers and drinkers of herbal infusions can also provide brewing material from which to brew their beverages. In all of these situations, a measured amount of brewing material is drawn from a bulk quantity of the brewing material, usually with a spoon or other scoop. Conventional spoons and scoops tend to heap dry material when drawn, resulting in an imprecise and inconsistent measurement.

It would be beneficial for a scoop to have an implement that can level the amount of dry material drawn in the scoop, so as to provide a reliable measurement of the material. It would also be beneficial if the scoop can be used to scoop any type of powder or ground, dry material. It would also be advantageous if the leveling action of the scoop can be performed single-handedly during preparation of a beverage or other operation. Such a scoop can be used, for example, to make espresso from a refillable, reusable cartridge that provides the convenience of prepackaged espresso cartridges with the capability of using any coffee or other brewing material.

### BRIEF SUMMARY OF THE INVENTION

The invention addresses the above and other needs by providing a scoop and with a level for scooping a portion of granulated material and leveling the contents of the scoop. The scoop can, for example, have a volume suitable for brewing a single serving of brewed beverage, such as espresso, although it is contemplated that the scoop can have any size suitable for use in measuring any powdered, dry, or granular material for any purpose, including for baking. A leveling element coupled to the scoop slides over the scoop to displace excess material, thus providing a reliable measured amount of material, for example, for preparing a beverage. A scoop handle can also include a tamper, which can be used to tamp brewing material after scooping, leveling, and pouring the brewing material into a holder.

According to an aspect of the invention, a scooping and leveling device includes an elongated scoop arm, a scoop arranged at a first end of the scoop arm, and a leveling element. The scoop has a concave interior and a substantially planar rim. The leveling element has a leveling arm coupled to the scoop arm, and a leveling bar disposed at a first end of the leveling arm. The leveling bar has substantially the same size and shape as at least a portion of the substantially planar rim of the scoop. The leveling arm is coupled to the scoop arm such that the leveling element is movable between a first position and a second position. In the first position, the leveling element is disposed such that the leveling bar is disposed on the at least a portion of the substantially planar rim of the scoop. In the second position, the leveling element is disposed such that the first end of the leveling arm is disposed beyond a far end of the substantially planar rim of the scoop.

The leveling bar can be planar with the leveling arm.

Top and bottom surfaces of the leveling bar can be planar with respective top and bottom surfaces of the leveling arm.

The leveling bar can have substantially the same size and shape as only a portion of the substantially planar rim of the scoop. For example, the substantially planar rim of the scoop can be circular, and the leveling bar can be a semi-circular arc.

The leveling bar can be flat.

The leveling bar can have substantially the same size and shape as only a portion of the substantially planar rim of the scoop. For example, the leveling bar can have substantially the same size and shape as a half of the substantially planar rim of the scoop nearest the first end of the scoop arm.

The leveling arm can be coupled to the scoop arm such that the leveling arm slides longitudinally along the scoop arm. For example, the leveling arm can include a longitudinal guide, the scoop arm can include a longitudinal channel, and the leveling arm and the scoop arm can be configured to couple together such that the longitudinal guide slides along the longitudinal channel. The longitudinal channel can be configured to capture the longitudinal guide.

The leveling arm can include a textured portion.

The leveling arm can be coupled to the scoop arm such that the leveling arm pivots about a point on the scoop arm. For example, the substantially planar rim of the scoop can be circular, and the leveling bar can be a semi-circular arc.

The device can also include a handle disposed at a second end of the scoop arm, and a tamper disposed at an end of the handle opposite the scoop arm. For example, the tamper can have a transverse cross-section that is smaller than the transverse cross-section of the handle. The transverse cross-section of the tamper can be, for example, round. The device can also include a guide pin disposed on an end of the tamper opposite the handle.

According to another aspect of the invention, a scoop with a level is provided to fill a bottom-fillable espresso cartridge. Such an espresso cartridge can include a cartridge base having frustoconical-shaped walls, an open bottom, and a sealed top or an open top with sealing material, and a bottom plug attachable to the bottom of the cartridge base. The base is shaped like known espresso cartridges having a frustoconical shape, with the top diameter larger than the bottom diameter. After filling through the bottom, the plug is pressed into the bottom of the cartridge base to complete the espresso cartridge. The plug can include preformed ports for releasing brewed espresso, or weakened areas can be provided in the plug, which seal the espresso cartridge after construction and rupture during use.

According to another aspect of the invention, a scoop with a level is provided as an element of a countertop tool, used in a method for constructing an espresso cartridge, the scoop and level configured to scoop and measure a single serving of brewing material. The tool includes a tool base configured to be supported on a generally horizontal surface, a cartridge seat having locking features on the tool base, a cartridge lock configured to engage the locking features to retain a cartridge base on the cartridge seat and including a mouth aligned with the open cartridge base bottom of the cartridge base, a funnel insertable into the mouth of the cartridge lock to facilitate pouring the single serving of brewing material into the mouth and cartridge base, a tamper for tamping the single serving of brewing material in the cartridge base, and a seating tool for seating the bottom plug in the open cartridge base bottom of the cartridge base. The method includes placing a frustoconical-shaped brewing cartridge base onto a cartridge seat of a tool base, a closed cartridge base top against the cartridge seat, the cartridge base top having a larger diameter than an open cartridge base bottom opposite the cartridge base top, attaching a cartridge lock to the tool base to retain the cartridge base against the tool base, scooping a portion of brewing material, leveling the brewing material in the scoop and level, pouring the brewing material through a mouth of the cartridge lock and the open bottom end of the cartridge base, into the cartridge base, tamping the untamped brewing material into the cartridge base, placing a bottom plug into the cartridge holder against the small end of the cartridge, seating the bottom plug into the cartridge base, and removing the finished cartridge from the tool.

According to another aspect of the invention, a tool is provided for use with the countertop tool and with the method for constructing an espresso cartridge, which provides scooping, leveling, tamping, and seating features. The multi-use tool provides a scoop to collect a serving of brewing material, a sliding level to measure an accurate amount of the brewing material before pouring the brewing material into the espresso cartridge, a tamper to tamp the brewing material in the espresso cartridge, and a guide hole pin to center a bottom plug during seating using the multi-use tool.

### BRIEF DESCRIPTION OF THE DRAWINGS

FIG. 1 shows a bottom isometric view of an exemplary cartridge according to the invention.

FIG. 2A shows a top isometric view of an exemplary cartridge according to the invention with the cartridge base top open.

FIG. 2B shows a top isometric view of an exemplary cartridge according to the invention with the cartridge base top closed.

FIG. 3A shows a side view of an exemplary cartridge according to the invention.

FIG. 3B shows a top view of an exemplary cartridge according to the invention.

FIG. 3C shows a bottom view of an exemplary cartridge according to the invention.

FIG. 4 shows a cross-sectional view of an exemplary cartridge according to the invention taken along the line 4-4 of FIG. 3A.

FIG. 5 shows a top isometric view of an exemplary cartridge base according to the invention.

FIG. 6 shows a bottom isometric view of an exemplary cartridge base according to the invention.

FIG. 7A shows a side view of an exemplary cartridge base according to the invention.

FIG. 7B shows a top view of an exemplary cartridge base according to the invention.

FIG. 7C shows a bottom view of an exemplary cartridge base according to the invention.

FIG. 8 shows a cross-sectional view of an exemplary cartridge base according to the invention taken along the line 8-8 of FIG. 7A.

FIG. 9A shows a side view of an exemplary bottom plug according to the invention.

FIG. 9B shows a top view of an exemplary bottom plug according to the invention.

FIG. 9C shows a bottom view of an exemplary bottom plug according to the invention.

FIG. 10 shows a cross-sectional view of an exemplary bottom plug according to the invention taken along the line 10-10 of FIG. 9A.

FIG. 11 shows a top isometric view of an exemplary bottom plug according to the invention.

FIG. 12 shows a cross-sectional view of an exemplary bottom plug according to the invention taken along the line 10-10 of FIG. 9A.

FIG. 13 shows a bottom isometric view of an exemplary bottom plug according to the invention.

FIG. 14A shows an isometric view of an exemplary handheld tool according to the invention.

FIG. 14B shows an isometric view of an exemplary handheld tool according to the invention.

FIG. 14C shows an isometric view of an exemplary handheld tool according to the invention.

FIG. 14D shows an isometric view of an exemplary handheld tool according to the invention.

FIG. 15 shows an isometric view of a frame of an exemplary handheld tool according to the invention.

FIG. 16A shows a side view of a frame of an exemplary handheld tool according to the invention.

FIG. 16B shows a top view of a frame of an exemplary handheld tool according to the invention.

FIG. 16C shows a bottom view of a frame of an exemplary handheld tool according to the invention.

FIG. 16D shows a rear view of a frame of an exemplary handheld tool according to the invention.

FIG. 16E shows a front view of a frame of an exemplary handheld tool according to the invention.

FIG. 17A shows an isometric view of a tamper/seater of an exemplary handheld tool according to the invention.

FIG. 17B shows an isometric view of a tamper/seater of an exemplary handheld tool according to the invention.

FIG. 18A shows a side view of a tamper/seater of an exemplary handheld tool according to the invention.

FIG. 18B shows a rear view of a tamper/seater of an exemplary handheld tool according to the invention.

FIG. 19A shows an isometric view of an exemplary countertop tool according to the invention.

FIG. 19B shows an isometric view of an exemplary countertop tool according to the invention.

FIG. 20A shows a tool base of an exemplary countertop tool according to the invention.

FIG. 20B shows a tool base of an exemplary countertop tool according to the invention.

FIG. 20C shows a tool base of an exemplary countertop tool according to the invention with a cartridge lock.

FIG. 21A shows a side view of an exemplary funnel according to the invention.

FIG. 21B shows an isometric view of an exemplary funnel according to the invention.

FIG. 21C shows a top view of an exemplary funnel according to the invention.

FIG. 21D shows a bottom view of an exemplary funnel according to the invention.

FIG. 22 shows an isometric view of an exemplary cartridge lock according to the invention.

FIG. 23A shows a side view of an exemplary cartridge lock according to the invention.

FIG. 23B shows a side view of an exemplary cartridge lock according to the invention rotated 90 degrees.

FIG. 23C shows a top view of an exemplary cartridge lock according to the invention.

FIG. 23D shows a bottom view of an exemplary cartridge lock according to the invention.

FIG. 24 shows a cross-sectional view of an exemplary cartridge lock according to the invention taken along the line 24-24 of FIG. 23C.

FIG. 25A shows an exemplary scoop and leveling tool according to the invention with a leveling fork retracted.

FIG. 25B shows an exemplary scoop and leveling tool according to the invention with the leveling fork extended.

FIG. 26A shows an isometric view of an exemplary leveling fork according to the invention.

FIG. 26B shows a cross-sectional view of a scoop arm of an exemplary scoop and level tool according to the invention, taken along the line 26B-26B of FIG. 25B.

FIG. 27 A shows a side view of an exemplary scoop and leveling tool according to the invention with the leveling fork retracted.

FIG. 27B shows atop view of an exemplary scoop and leveling tool according to the invention with the leveling fork retracted.

FIG. 28A shows a side view of an exemplary scoop and leveling tool according to the invention with the leveling fork extended.

FIG. 28B shows a top view of an exemplary scoop and leveling tool according to the invention with the leveling fork extended.

FIG. 29 shows an isometric view of an exemplary seating tool according to the invention.

FIG. 30A shows a side view of an exemplary seating tool according to the invention.

FIG. 30B shows a bottom view of an exemplary seating tool according to the invention.

FIG. 31 shows a side view of an exemplary handheld tool according to the invention, in an open state.

FIG. 32 shows a side view of an exemplary handheld tool according to the invention, in a closing state.

FIG. 33 is a flow diagram of an exemplary method according to the invention.

FIG. 34 shows a flow diagram of an exemplary method according to the invention.

FIG. 35A shows an isometric view of an exemplary countertop tool according to the invention.

FIG. 35B shows an isometric view of an exemplary countertop tool according to the invention.

FIG. 36A shows an isometric view of an exemplary scoop/leveling/tamper/seating tool according to the invention.

FIG. 36B shows an isometric view of an exemplary scoop/leveling/tamper/seating tool according to the invention.

FIG. 36C shows an isometric view of an exemplary scoop/leveling/tamper/seating tool according to the invention.

FIG. 37A shows an isometric view of an exemplary scoop/leveling/tamper/seating tool according to the invention, with a sliding level retracted.

FIG. 37B shows an isometric view of an exemplary scoop/leveling/tamper/seating tool according to the invention, with the sliding level partially extended.

FIG. 37C shows an isometric view of an exemplary scoop/leveling/tamper/seating tool according to the invention, with the sliding level fully extended.

FIG. 38 shows an exemplary scoop/leveling/tamper/seating tool according to the invention releasing brewing material into an espresso cartridge retained in the tool base.

FIG. 39 shows an exemplary scoop/leveling/tamper/seating tool according to the invention positioned to tamp brewing material in an espresso cartridge retained in the tool base.

FIG. 40 shows an exemplary scoop/leveling/tamper/seating tool according to the invention positioned to seat the bottom plug in an espresso cartridge retained in the tool base.

FIG. 41A shows an exemplary scoop/leveling/tamper/seating tool according to the invention, having a pivoting level.

FIG. 41 B shows an exemplary scoop/leveling/tamper/seating tool according to the invention, having a pivoting level.

Corresponding reference characters indicate corresponding components throughout the several views of the drawings.

### DETAILED DESCRIPTION OF THE INVENTION

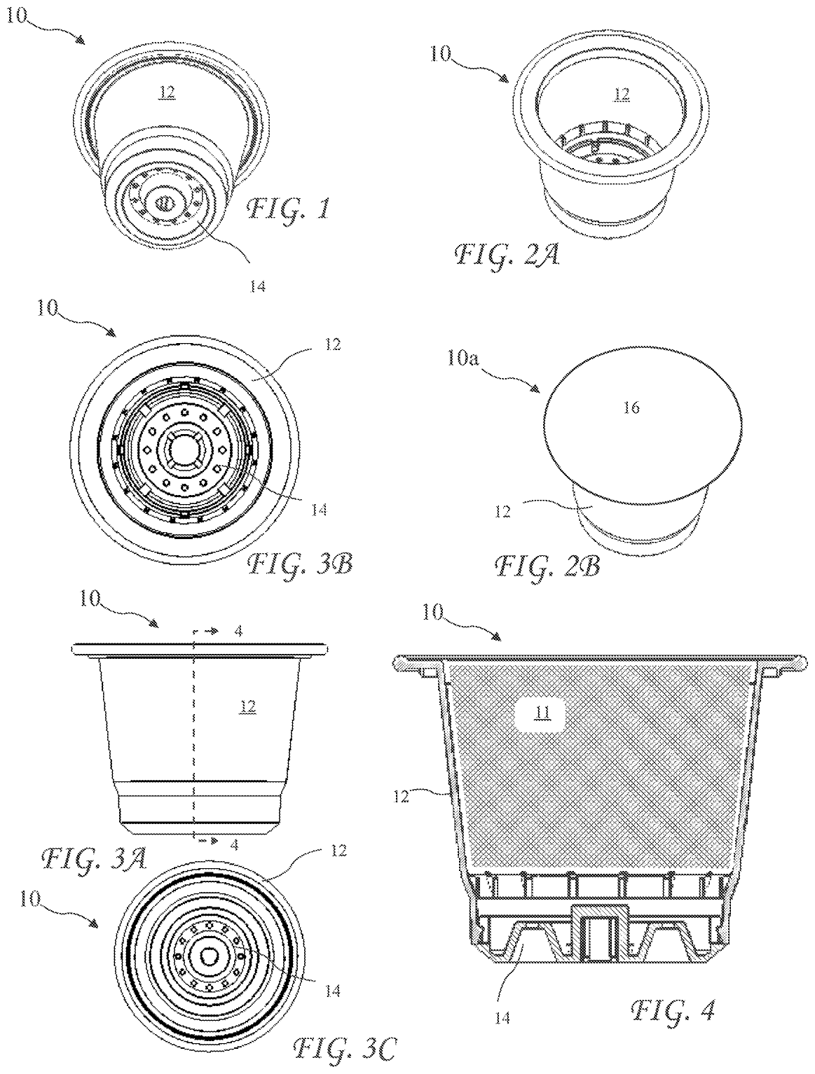

Referring to FIGS. 1, 2A, 2B, 3A-3C, and 4, an exemplary espresso cartridge 10 according to the invention includes a base 12, which can have an open top 12a, or which can have foil material 16 or the like sealing the cartridge base top 12a. When the cartridge is provided with the cartridge base top 12a open, the foil material 16 can be attached to the cartridge base 12 before filling the cartridge base 12 with brewing material. A bottom plug 14 is inserted into the cartridge base 12 after filling the cartridge base 12 through an open cartridge base bottom 12b (see FIG. 8).

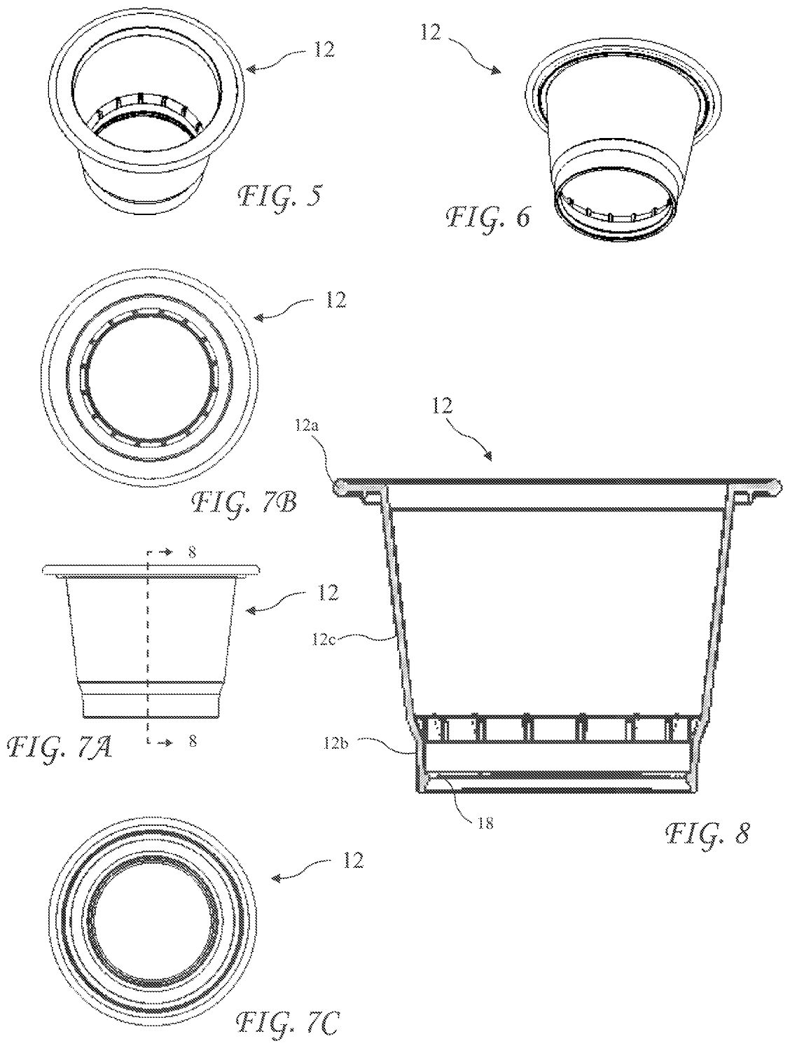

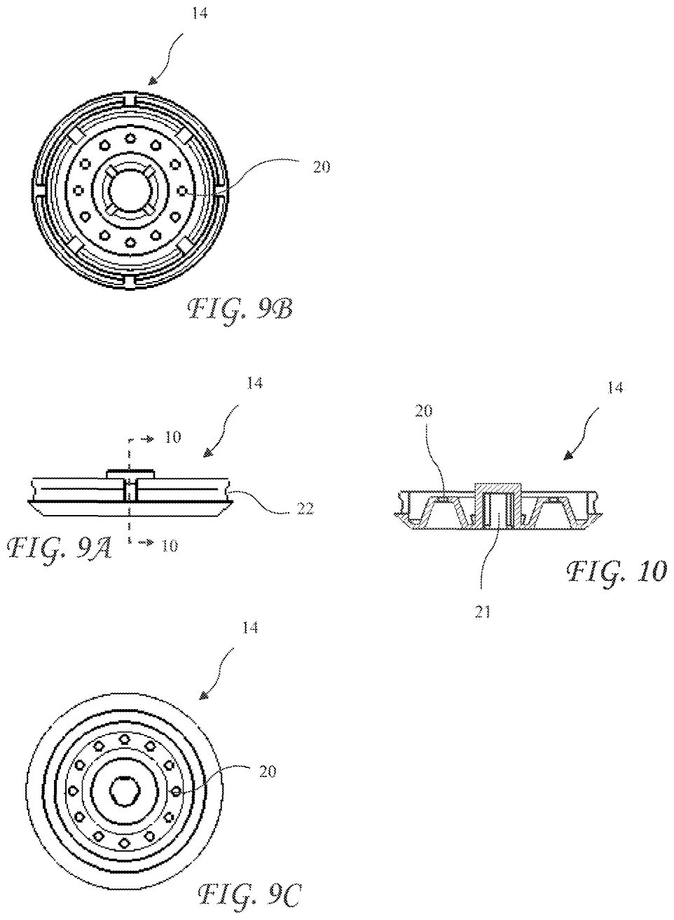

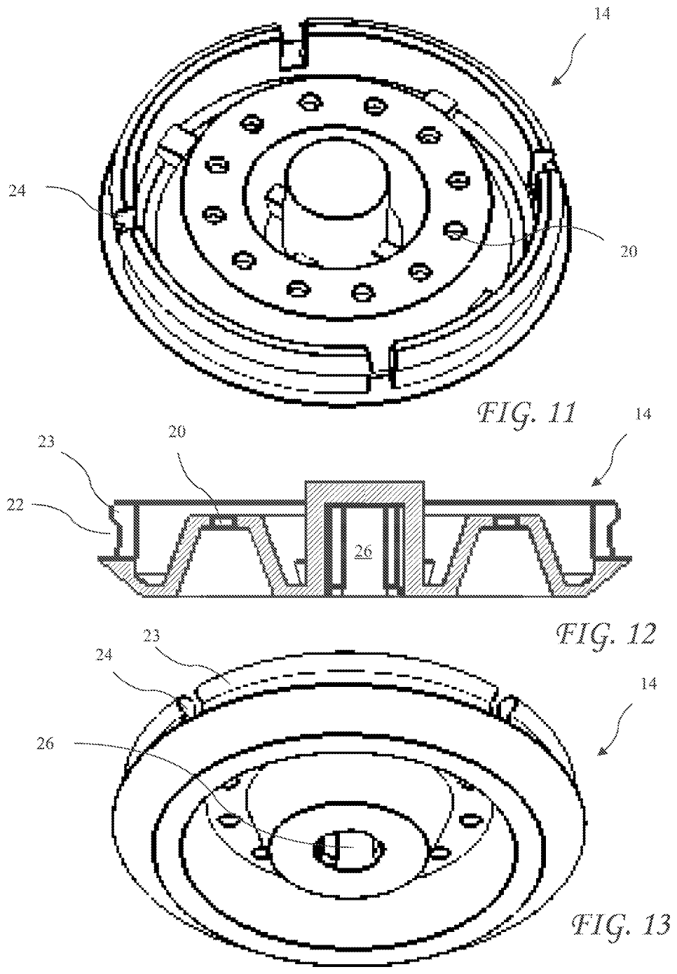

Referring to FIGS. 5, 6, 7A-C, and 8, the cartridge base 12 includes a sidewall 12c spanning between the base top 12a and the base bottom 12b. Although shown as being frustoconical in shape, the sidewall 12c can take any shape, and can be rounded, polygonal, or irregular in cross-section. In the frustoconical embodiment shown, the base bottom 12b has a smaller diameter than the base top 12a. An interior annular ridge 18 in the base bottom 12b engages an exterior annular recess 22 (see FIG. 9A) in the bottom plug 14 to retain the bottom plug 14 in the base bottom 12b.

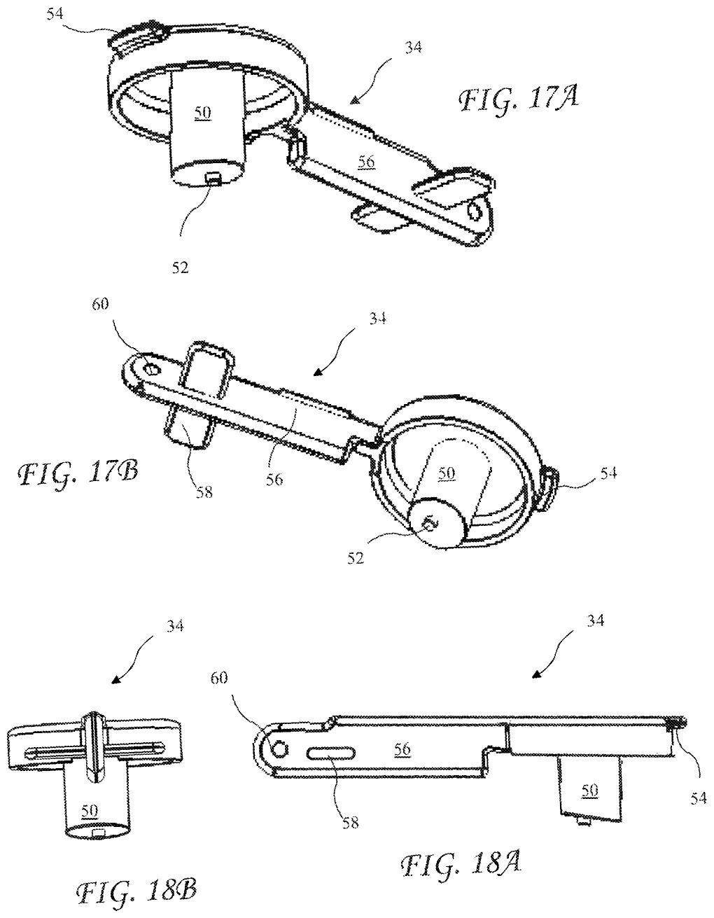

Referring to FIGS. 9A-C, and 10-13, an edge of the bottom plug 14 has a lip 23 above an exterior annular recess 22. The lip 23 includes gaps 24 allowing the lip 23 to slightly distort when the bottom plug 14 is pressed into the open base bottom 12b. The bottom plug 14 also includes ports or weakened areas 20; when espresso is brewed using the cartridge 10, the brewed beverage escapes from the cartridge 10 through the ports or weakened areas 20. The weakened areas 20 help seal the cartridge 10 before use. The bottom plug 14 can also include a guide hole 26, which engages a guide hole pin 52 (see FIG. 17A) to hold the bottom plug in place during assembly of the cartridge 10.

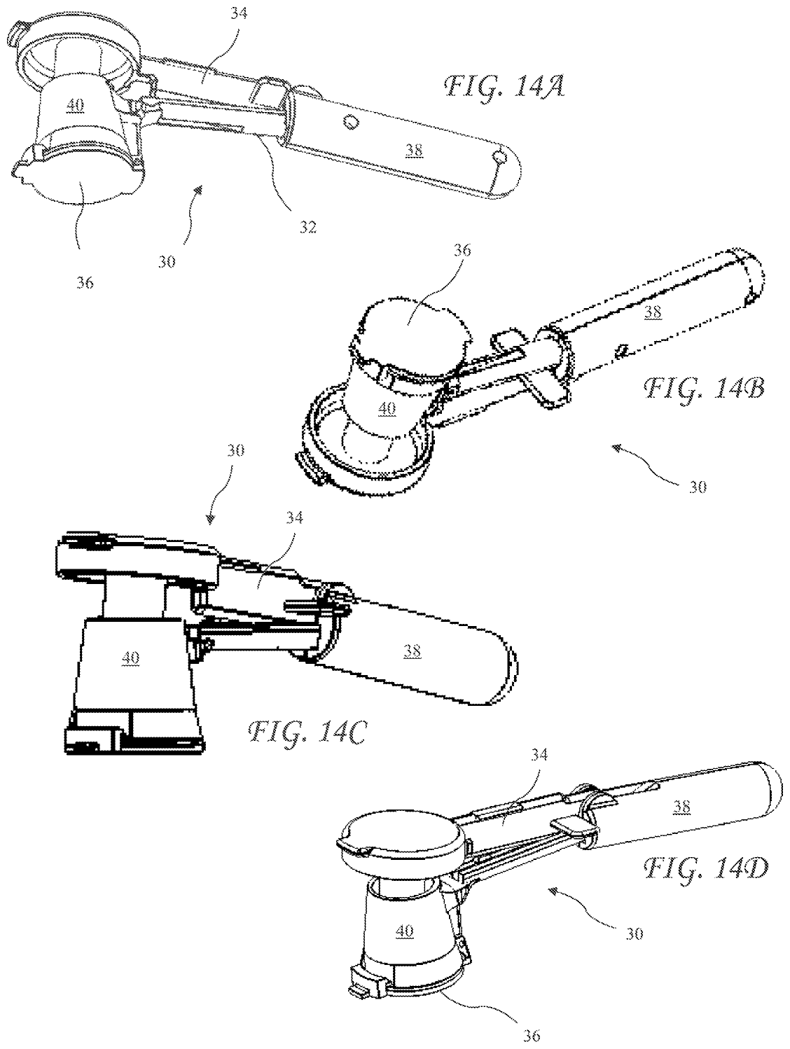

Referring to FIGS. 14A-14D a handheld tool 30 includes a frame 32, a handle 38 attached to the frame 32 for grasping by a user, a cartridge holder 40, a cartridge hole lid 36, and a tamper/seater 34. The cartridge base 12 is held in the cartridge holder 40 while the cartridge 12 is filled, tamped, and plugged to construct an espresso cartridge 10.

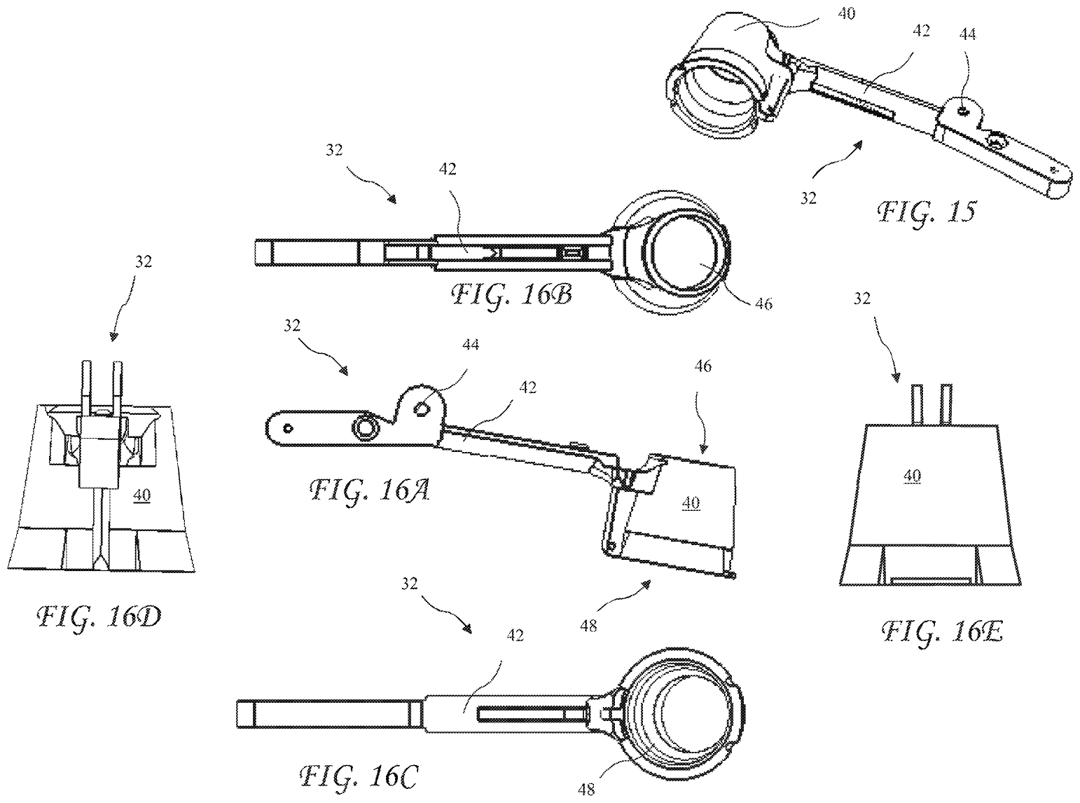

Referring to FIGS. 15 and 16A-E, the frame 32 of the handheld tool 30 includes the cartridge holder 40, an arm 42 extending from the cartridge holder 40 to the handle 38, and pivot hands 44. The cartridge holder 40 has an open scoop mouth 46 and an open cartridge mouth 48, the latter of which can be closed by the lid 36 after placing the cartridge base 12 in the cartridge holder 40. The cartridge holder 40 can have an exterior having any shape, such as cylindrical or a frustoconical, but preferably has an interior shape matching or corresponding to that of the walls 12c of the cartridge base 12, which is frustoconical in the exemplary embodiment shown.

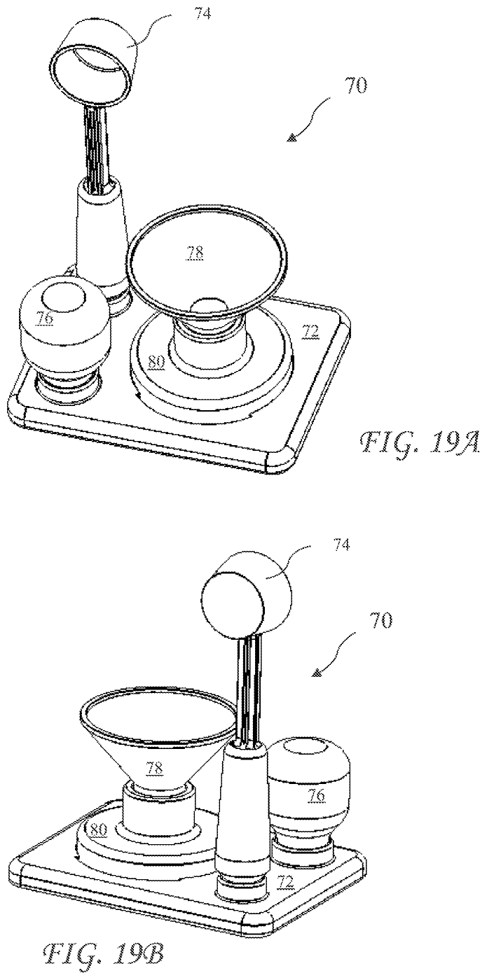

Referring to FIGS. 17A and B and FIGS. 18A and B, the tamper/seater 34 of the handheld tool 30 can be used to make the espresso cartridge 10. A pivot 60 cooperates with the pivot hands 44 of the frame 32, allowing the tamper/seater 34 to pivot toward and away from the cartridge holder 40. A tamping plunger 50 is pushed into the cartridge holder 40 to tamp brewing material in the cartridge base 12. After tamping, the tamping plunger 50 is used to press the bottom plug 14 into the cartridge base 12. The tamping plunger 50 can include a guide hole pin 52 to attach the bottom plug 14 to the tamping plunger 50 to hold the bottom plug 14 aligned with the cartridge base bottom 12b while pressing the bottom plug 14 into the cartridge base bottom 12b. The tamper/seater 34 can include wings 58 to facilitate one-handed operation of the tool 30. A tamper arm 56 connects the pivot 60 to the tamper plunger 50.

Referring to FIGS. 19A and B, a countertop tool 70 includes a tool base 72, a cartridge lock 80 configured to retain the cartridge base 12 on the tool base 72, a funnel 78 configured to fill the cartridge base 12, a scoop and leveling tool 74 configured to measure and pour brewing material, and a seating tool 76 configured to seat the bottom plug after the cartridge base 12 is filled with the brewing material.

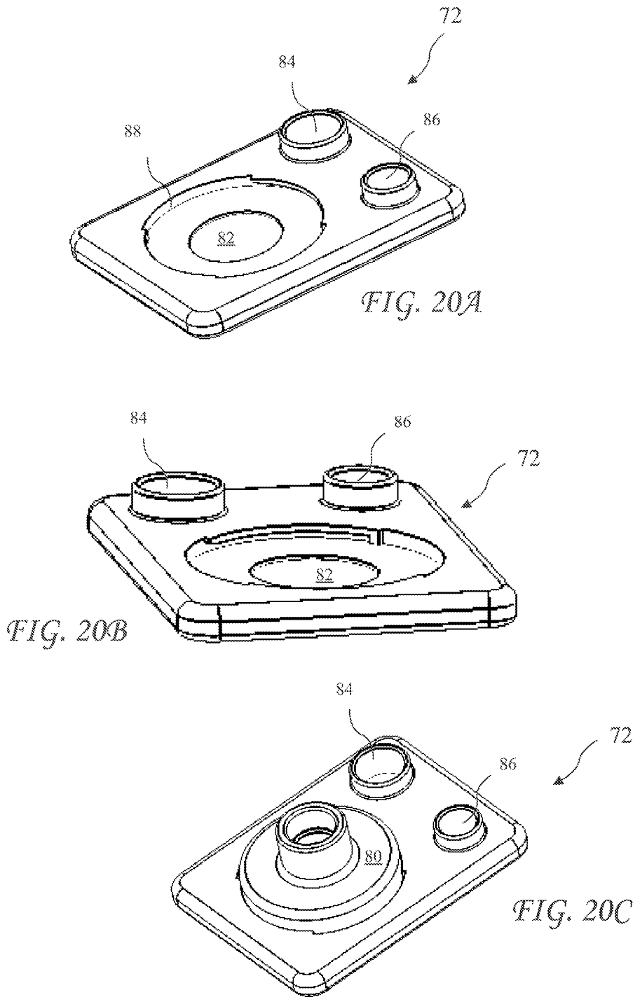

Referring to FIGS. 20A-C, a tool base 72 of the countertop tool 70 includes a cartridge seat 82 that is slightly larger than the cartridge top 12a, configured to position the cartridge 12 on the tool base 72. Locking recesses 88 are formed around the cartridge seat 82 and are configured to attach a cartridge lock 80 (see FIGS. 22-24) to the tool base 72 to hold the cartridge base 12 on the tool base 71. A recess 84 is formed on the tool base 72 to position or store the seating tool 76 when not in use and a recess 86 is formed to position or store the scoop and leveling tool 74 when not in use.

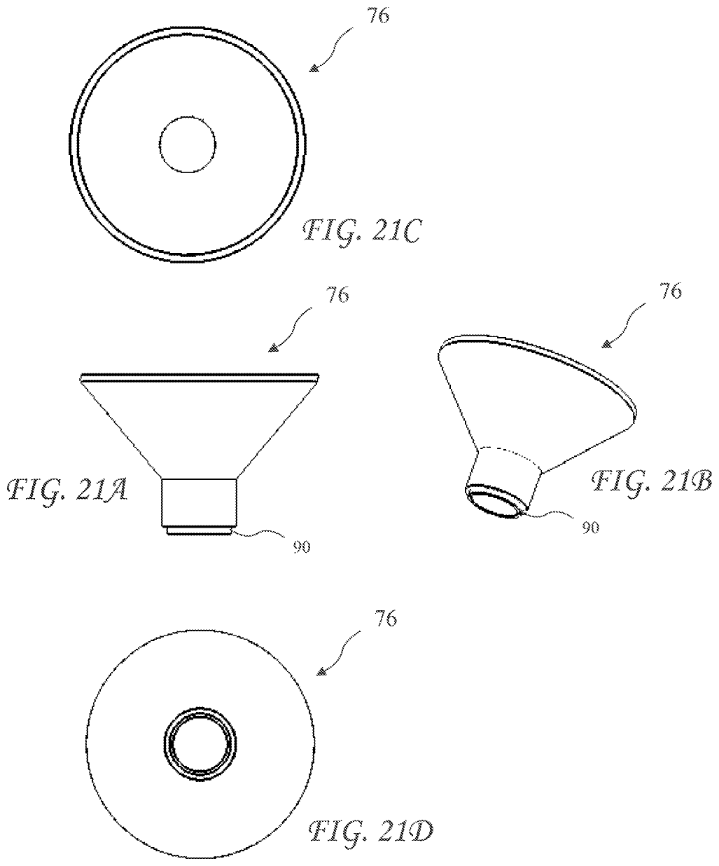

Referring to FIGS. 21A-D, a funnel 76 fits into a cylindrical access mouth 94 (see FIG. 24) of the cartridge lock 80. The funnel 76 can include a step 90 to align the funnel with the open base bottom 12b, or can be tapered to align the funnel with the open base bottom 12b.

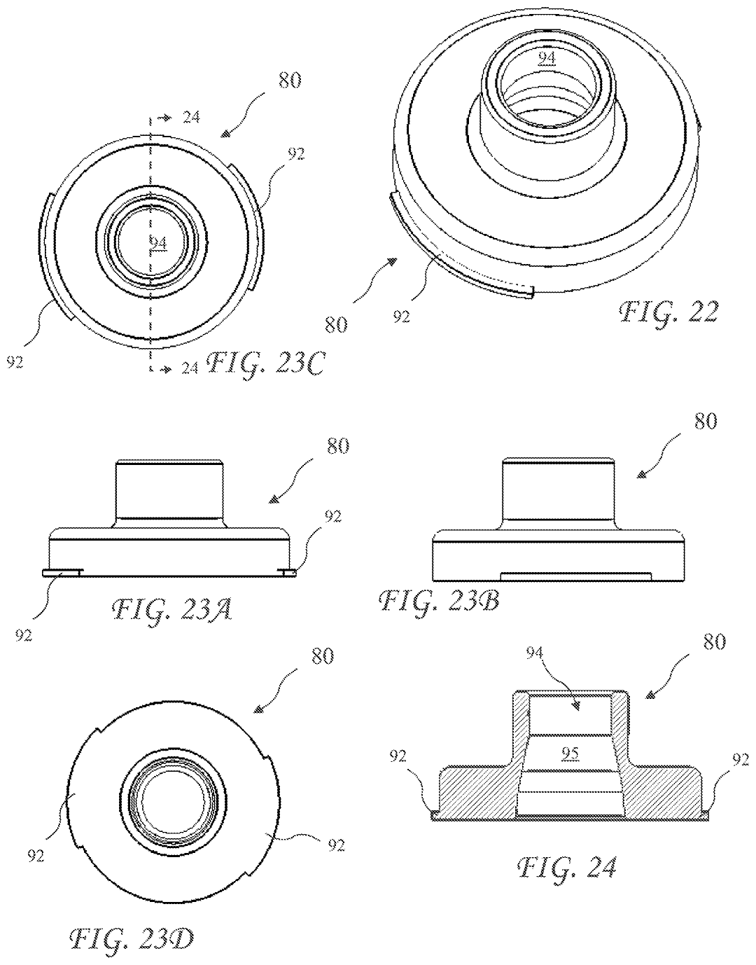

Referring to FIGS. 22, 23A-D, and 24, a cartridge lock 80 includes locking ring segments 92 that engage the locking recesses 88 of the tool base 72 to retain the cartridge lock 80 and the cartridge base 12 on the tool base 72. The cartridge lock 80 includes a frustoconical-shaped interior 95 arranged to position the cartridge base 12 in the cartridge lock 80 for filling, tamping, and seating the bottom plug 14.

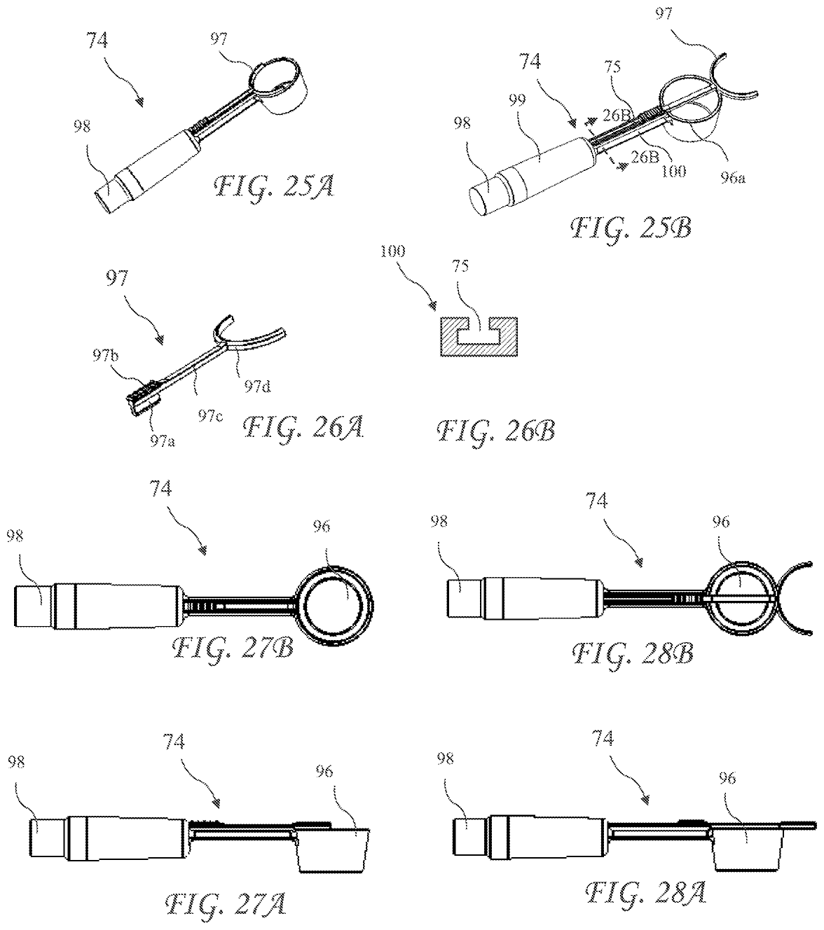

Referring to FIGS. 25A and B, 26A and B, 27A and B, and 28A and B, an exemplary scoop and leveling tool 74 includes a leveling fork 97 that is restrained to slide in a channel 75 in the scoop and leveling tool 74. The leveling fork 97 includes a “T” shaped guide 97a that engages the channel 75, a thumb piece 97b for articulating the leveling fork 97, a fork 97d sliding horizontally over the scoop 96, and a level arm 97c connecting the thumb piece 97b to the fork 97d. The fork 97d is generally flat and rests on a rim 96a of the scoop 96 when not in use. After scooping a portion of brewing material 11 (see FIG. 4), the leveling fork 97 can be guided forward to push excess brewing material off the scoop and leveling tool 74 to measure a consistent amount of brewing material 11.

As shown, the exemplary scoop and leveling tool 74 includes a cylindrical tamper 98 and a flat tamping end 51 opposite to the scoop 96. The cylindrical tamper 98 is slightly smaller in diameter than the cylindrical access mouth 94 of the cartridge lock 80 to allow the cylindrical tamper 98 to pass through the cylindrical mouth 94 during tamping.

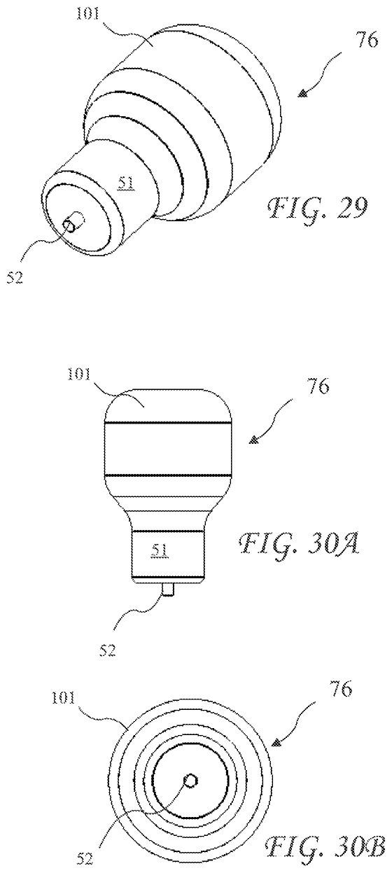

Referring to FIGS. 29 and 30A and B, a seating tool 76 includes a cylindrical portion 51 extending from a grasping portion 101. The grasping portion 101 facilitates applying a force required to seat the bottom plug 14 in the open cartridge bottom 12b. A guide hole pin 52 is provided to attach the bottom plug 14 to the seating tool 76, to hold the bottom plug 14 aligned with the cartridge base bottom 12b while pressing the bottom plug 14 into the cartridge base bottom 12b.

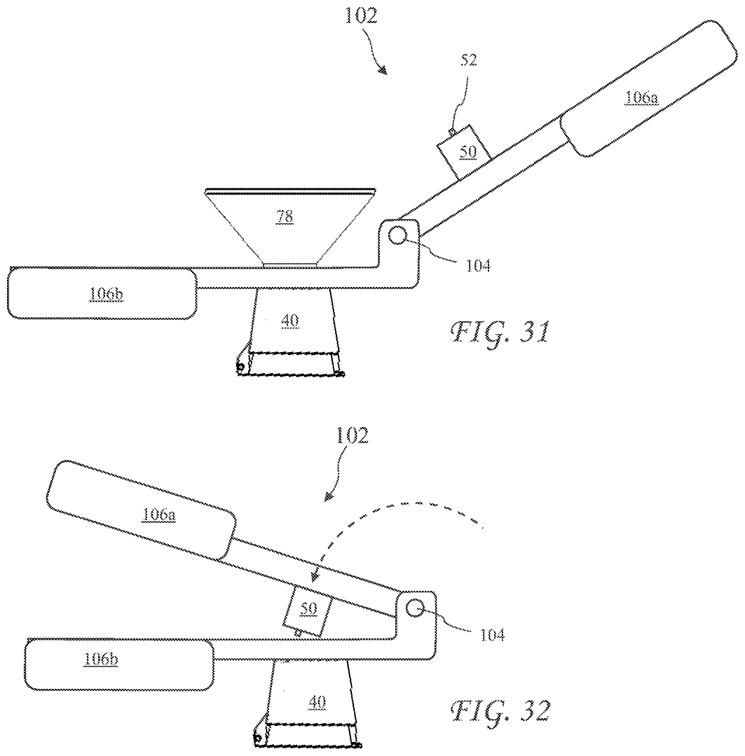

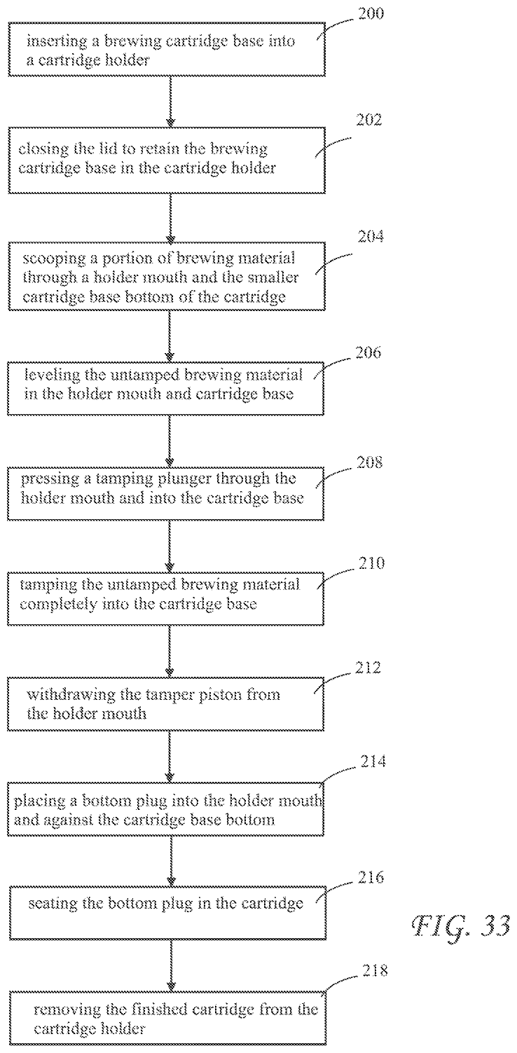

Referring to FIGS. 31 and 32, a handheld tool 102 includes a pivot 104 and handles 106a and 106b. The cartridge holder 40 is fixed to one handle 106b, and the tamper plunger 50 is attached to the handle 106a. The cartridge base 12 can be filled using the scoop and leveling tool 74 as described for the tool 70 above, and the handle 106a can be pivoted first to tamp the brewing material using the tamper plunger 50, and then to seat the bottom plug 14 using the tamper plunger 50, as described for the tool 30 above. The tool 102 advantageously provides leverage during tamping and seating, easing the use of the tool.

Referring to FIG. 33, a method according to the invention for using the handheld tool includes inserting 200 a frustoconical-shaped cartridge base into a cartridge holder, an open cartridge base bottom first into the cartridge holder, the cartridge base bottom diameter being smaller than a cartridge base top opposite to the cartridge base bottom, closing 202 a lid to retain the cartridge base in the cartridge holder, scooping 204 a portion of untamped brewing material through a holder mouth and the smaller cartridge base bottom of the cartridge, leveling 206 the untamped brewing material in the holder mouth and cartridge base, pressing 208 a tamping plunger through the holder mouth and into the cartridge holder, tamping 210 the untamped brewing material completely into the cartridge base, withdrawing 212 the tamper piston from the holder mouth, 214 placing a bottom plug into the holder mouth and against the smaller cartridge base bottom of the cartridge base, seating 216 the bottom plug in the smaller base bottom of the cartridge, and removing 218 the finished cartridge from the cartridge holder.

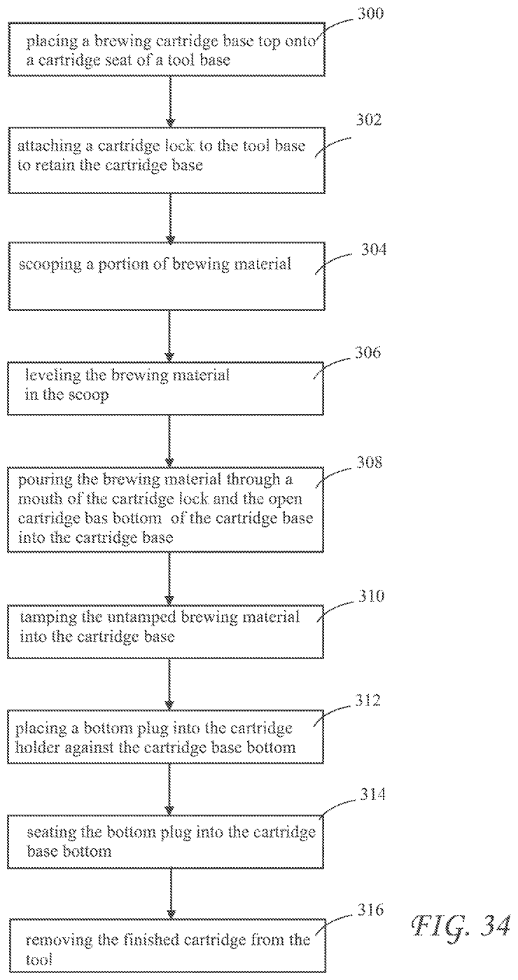

Referring to FIG. 34, a method according to the invention for using the tabletop tool includes placing 300 a frustoconical-shaped brewing cartridge base onto a cartridge seat of a tool base, a closed cartridge base top against the cartridge seat, the cartridge base top having a larger diameter than an open cartridge base bottom opposite the cartridge base top, attaching 302 a cartridge lock to the tool base to retain the cartridge base against the tool base, scooping 304 a portion of brewing material, leveling 306 the brewing material in the scoop, pouring 308 the brewing material through a mouth of the cartridge lock and the open bottom end of the cartridge base, into the cartridge base, tamping 310 the untamped brewing material into the cartridge base, placing 312 a bottom plug into the cartridge holder against the small end of the cartridge, seating 314 the bottom plug into the cartridge base, and removing 316 the finished cartridge from the tool.

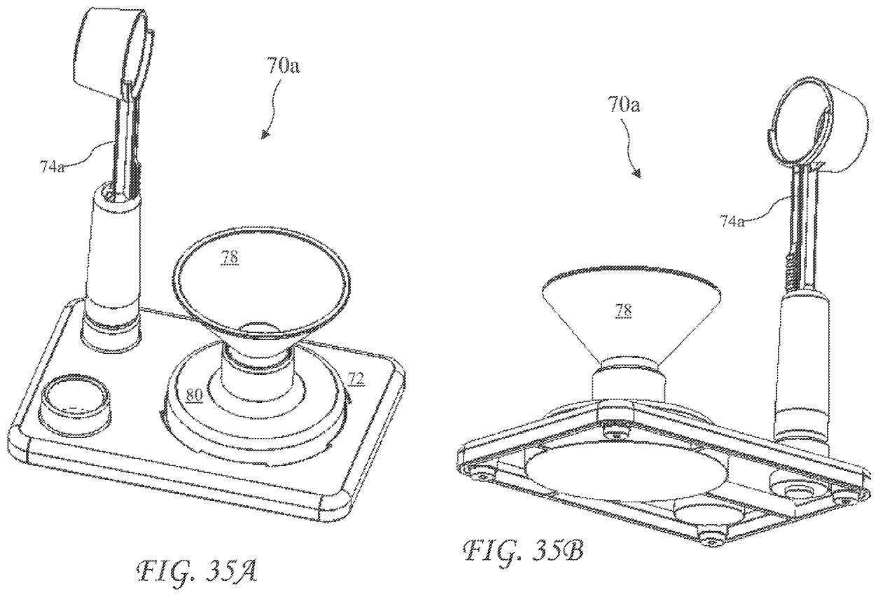

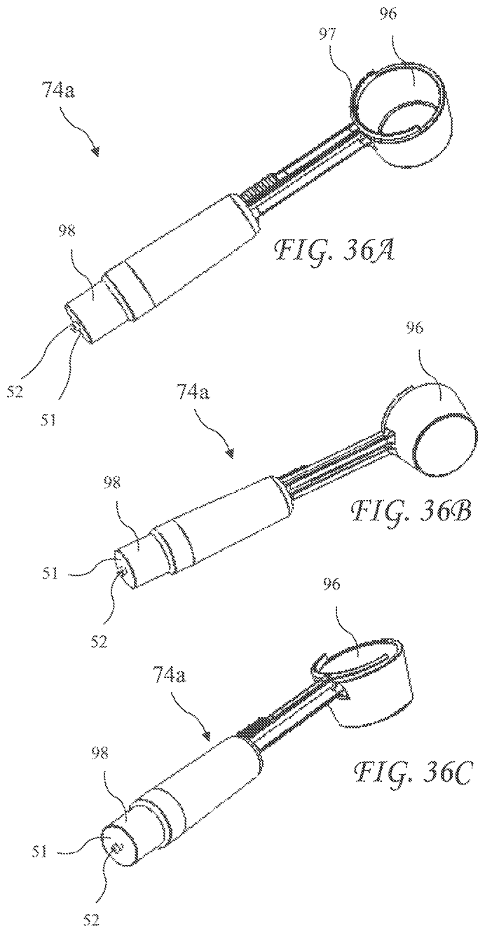

Referring to FIGS. 35A and B, an exemplary embodiment of a countertop tool 70a includes a multi-tool 74a in place of the scoop and leveling tool 74, and does not include the dedicated seating tool 76. Referring to FIGS. 36A-C, the multi-tool 74a is similar to the scoop and leveling tool 74, but includes a flat end 51 opposite to the scoop 96, and a guide hole pin 52 centered on the flat end 51.

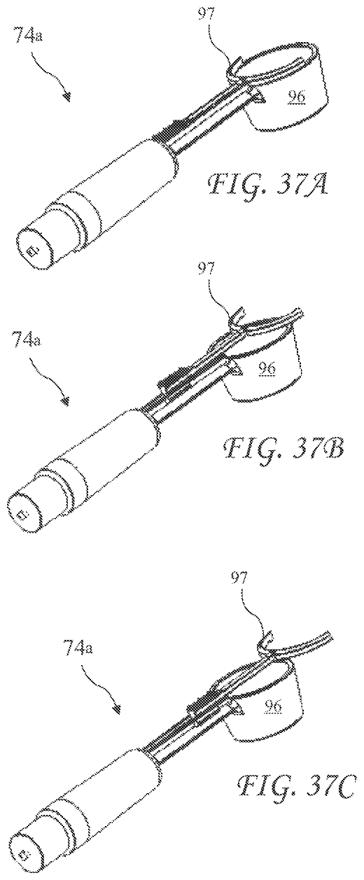

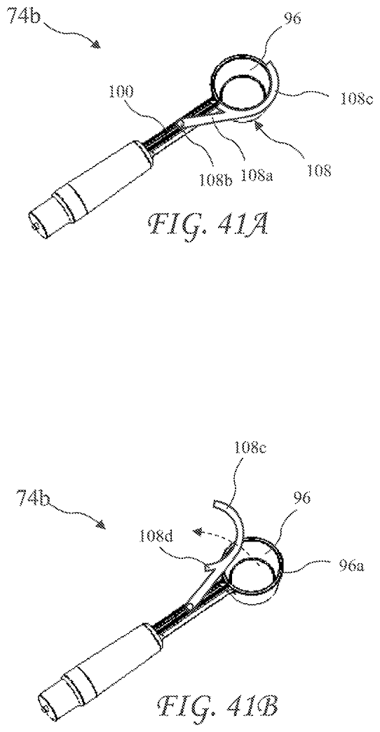

Referring to FIGS. 37A-C, after scooping brewing material from a bulk brewing material container, the sliding level can be used to level the brewing material in the scoop to obtain a preferred amount of brewing material for an espresso cartridge. While a sliding level 97 is shown in FIGS. 37A-C, a pivoting level can be used instead, and any apparatus usable to slide over the scoop 96 to level the brewing material is contemplated for use with the scoop of the invention. For example, as shown in FIGS. 41A and B, a pivoting level 108 includes a level arm 108a pivotally attached to a scoop arm 100 at a pivot 108b and a sickle 108c at an end of the arm opposite to the pivot 108b. The pivoting level 108 is generally flat and rests on a rim 96a of the scoop 96 when not in use, and pivots across the rim to remove excess material from the scoop. Although the level arm 108a is shown as being tangentially attached to the sickle 108c, the scoop arm 108a can instead couple to a near end 108d of the sickle 108c.

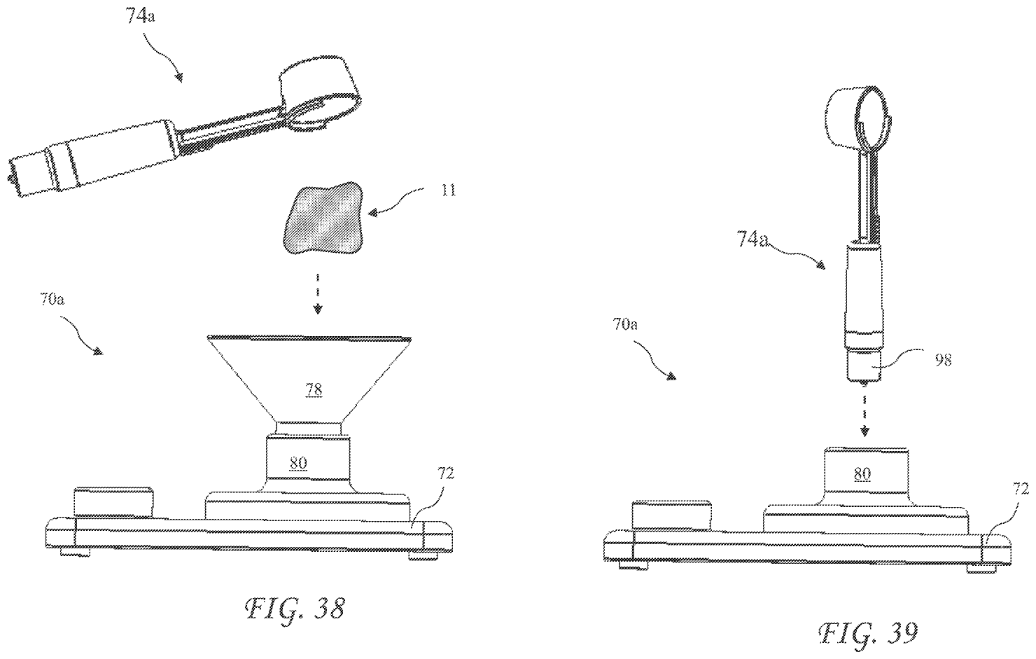

The multi-tool 74a is shown releasing brewing material 11 into the espresso cartridge retained in the tool base in FIG. 38. The funnel 78 is fitted to the cartridge lock to guide the brewing material 11 into the cartridge 10 (see FIGS. 1-8) that is locked to the tool base 72.

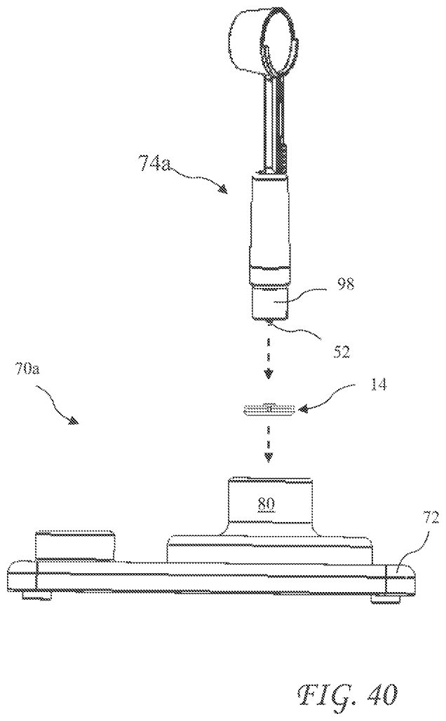

The multi-tool 74a is shown positioned to tamp the brewing material 11 in the espresso cartridge 10 retained in the tool base 72 in FIG. 39. The multi-tool 74a includes a cylindrical tamper portion 98 slightly smaller than the cylindrical access mouth 94 (see FIG. 24) of the cartridge lock 80 to allow the cylindrical tamper portion 98 to enter the cartridge.

The multi-tool 74a is shown positioned to seat, the bottom plug 14 in the espresso cartridge 10 retained by the cartridge lock 80 in the tool base 72 in FIG. 40. The guide hole pin 52 engages the guide hole 21 of the bottom plug 14 and the cylindrical tamper portion 98 centers the bottom plug 14 for seating in the espresso cartridge 10.

Thus, in general a scooping and leveling device of the invention includes an elongated scoop arm, a scoop arranged at a first end of the scoop arm, and a leveling element. The scoop has a concave interior and can take any regular or irregular shape, but preferably includes a substantially planar rim. The scoop can have a fixed size and shape, or can be adjustable to change the desired volume of the scoop. The scoop can be made from a solid, continuous construction so as to be able to take and hold any type of material, solid or liquid. Alternatively, the scoop can be constructed from strips or can have perforations, so that it can function as a sieve so that the scooped material conforms to a desired granular size.

The leveling element has a leveling arm coupled to the scoop arm, and a leveling bar disposed at a first end of the leveling arm, closest to the scoop. The leveling bar can be a straight piece of a size at least the width of the rim of the scoop, or can take any other shape. Preferably, the leveling bar has substantially the same size and shape as at least a portion of the substantially planar rim of the scoop, so that it can rest on the rim of the scoop and occupy the least amount of space on the scoop prior to leveling the contents of the scoop. Alternatively, the leading edge of the leveling bar can take the shape of a portion of the substantially planar rim of the scoop, but a region behind the leading edge can be solid, that is, can provide a cover for the scoop as the leveling bar is pushed across the scoop, to ensure that excess scooped material does not fall back over the leveling bar and into the scoop. Alternatively, or in addition, the leveling bar can have a lip or raised portion at the leading edge to provide more surface area to push or plow heaped material from above the rim of the scoop.

If the leveling bar does not include such a lip or raised portion the leveling bar can be planar with the leveling arm so as to maintain a low profile and reduce the amount of material necessary to fabricate the device. For example, top and bottom surfaces of the leveling bar can be flat, and can be planar with respective top and bottom surfaces of the leveling arm, maintaining a continuous profile across the leveling arm and leveling bar, The leveling bar can have substantially the same size and shape as only a portion of the substantially planar rim of the scoop, such as of half the rim, or any other portion of the rim. For example, the substantially planar rim of the scoop can be circular, and the leveling bar can be a semi-circular arc, although any shape, regular or irregular, is contemplated as being included within the scope of the invention.

The leveling arm is coupled to the scoop arm such that the leveling element is movable between a first position and a second position. While in the first position, material will be scooped using the device, so the leveling element is disposed such that the leveling bar is in a pre-leveling position. For example, in the first position the leveling bar can be disposed on the substantially planar rim of the scoop, although it can be disposed farther back from the scoop, as long as it does not block the scoop opening. Material in the scoop is leveled at the scoop rim as the leveling element moves from the first position to the second position. In the second position, leveling of the material in the scoop should be completed, and therefore the leveling element is disposed such that the first end of the leveling arm is disposed beyond a far end of the substantially planar rim of the scoop. Thus, the scoop is used to take up material from a bulk source of the material while the leveling element is in the first position, preferably resulting in a heaping amount of material being present in the scoop. Then the leveling element is moved from the first position to the second position, in the process pushing the material that is heaped above the scoop rim off and over the side of the scoop, typically back into the bulk source of the material. The leveling element can then be returned to the first position, and the scooped, leveled material can be dispensed as desired. The leveling arm can include a textured portion, such as a knurled region, to provide additional friction for the user to push against while moving the leveling element. All of the described features facilitate use of the device to scoop, level, and dispense material with a single hand if desired.

Thus, the leveling arm is coupled to the scoop arm in a manner that allows the leveling arm to move with respect to the scoop arm. For example, the leveling arm can be coupled to the scoop arm such that the leveling arm slides longitudinally along the scoop arm. As an example, the leveling arm can include a longitudinal guide, the scoop arm can include a longitudinal channel, and the leveling arm and the scoop arm can be configured to couple together such that the longitudinal guide slides along the longitudinal channel. Although the leveling arm and scoop arm are coupled so as to be able to move in this manner, it is preferable that the leveling arm and the scoop arm remain in fixed relative positions, that is, are restrained from being completely uncoupled, at least in moving between the first and second positions. For example, the longitudinal channel can be configured to capture the longitudinal guide, such as by having a “T” shape that corresponds to a “T” shape of the guide, although any other means of capture can be used. Further, the motion between the first and second positions can be biased in either direction, such as by placement of a spring or the like at one end to urge movement of the leveling arm with respect to the scoop arm. Configured thusly, positive effort would be required to move the leveling element from the first position to the second position, or from the second position to the first position, but not in the other direction.

Although sliding coupling between the leveling arm and the scoop arm has been described, coupling that allows any relative motion causing the leveling bar to pass across the rim of the scoop is contemplated for use with the device of the invention. For example, the leveling arm can be coupled to the scoop arm such that the leveling arm pivots about a point on the scoop arm. In such a case, the leveling arm can move radially with respect to the scoop arm, and the leveling bar can sweep heaped material from above the rim of the scoop. For example, the substantially planar rim of the scoop can be circular, and the leveling bar can be a semi-circular arc. In such a case, or in any similar embodiment, an end of the leveling arm itself can pushed the heaped material from above the rim, and a separate leveling arm might not be necessary.

With or without the leveling feature, the scoop can include a built-in tamper, providing an element to tamp the dispensed material if desired, without the need for a separate tool or device. For example, the device can include a handle disposed at a second end of the scoop arm, the end opposite from the scoop. A tamper can be disposed at the end of this handle. Thus, once dispensed from the scoop into a holder or other vessel, the material can be tamped using the other end of the device, again allowing for single-handed operation. The tamper can be of any size suitable for the anticipated holder and usable with the other elements of the device of the invention. For example, the tamper can have a transverse cross-section that is smaller than the transverse cross-section of the handle, to make it easier to tamp the material while grasping the handle. The transverse cross-section of the tamper can be, for example, round, or any other shape. The device can also include a guide pin disposed on an end of the tamper opposite the handle, for use in centering or otherwise positioning the tamper in a holder while tamping.

As described, the device of the invention is particularly suitable for use for scooping, measuring, leveling, dispensing, and tamping ground beverage brewing material such as ground coffee beans, tea leaves, herbs, and the like. However, the device can be used for any application in which a ground, powdered, granulated, or otherwise dry bulk material is you be scooped in a measured amount. For example, in baking applications, the scoop device can be used to measure and dispense quantities of flour, sugar, and other ingredients. Pharmaceutical applications and hobby and craft applications can find beneficial use of the device of the invention, as can, for example, building applications if the scoop is provided in larger dimensions for handling greater volumes.

The invention has been described by way of example and in terms of preferred embodiments. However, the present invention as contemplated by the inventor is not strictly limited to the particularly disclosed embodiments. To the contrary, various modifications, as well as similar arrangements, are included within the spirit and scope of the present invention. The scope of the appended claims, therefore, should be accorded the broadest reasonable interpretation so as to encompass all such modifications and similar arrangements.

1. A scooping and leveling device, comprising:
an elongated scoop arm;
a scoop arranged at a first end of the scoop arm; and
a leveling element;
wherein the scoop has a concave interior and a substantially planar rim;
wherein the leveling element has a leveling arm coupled to the scoop arm, and a leveling bar disposed at a first end of the leveling arm;
wherein the leveling bar has substantially the same size and shape as at least a portion of the substantially planar rim of the scoop;
wherein the leveling arm is coupled to the scoop arm such that the leveling element is movable between a first position and a second position;
wherein in the first position, the leveling element is disposed such that the leveling bar is disposed on the at least a portion of the substantially planar rim of the scoop; and
wherein in the second position, the leveling element, is disposed such that the first end of the leveling arm is disposed beyond a-far an opposite end of the substantially planar rim of the scoop.

2. The device of claim 1, wherein the leveling bar is planar with the leveling arm.

3. The device of claim 1, wherein top and bottom surfaces of the leveling bar are planar with respective top and bottom surfaces of the leveling arm.

4. The device of claim 1, wherein the leveling bar has substantially the same size and shape as only a portion of the substantially planar rim of the scoop.

5. The device of claim 4, wherein the substantially planar rim of the scoop is circular.

6. The device of claim 5, wherein the leveling bar is a semi-circular arc.

7. The device of claim 1, wherein the leveling baric flat does not have a raised cross-sectional profile with respect to that of the leveling arm.

8. The device of claim 1, wherein the leveling bar has substantially the same size and shape as only a portion of the substantially planar rim of the scoop.

9. The device of claim 8, wherein the leveling bar has substantially the same size and shape as a half of the substantially planar rim of the scoop nearest the first end of the scoop arm.

10. The device of claim 1, wherein the leveling arm is coupled to the scoop arm such that the leveling arm slides longitudinally along the scoop arm.

11. The device of claim 10, wherein:
the leveling arm includes a longitudinal guide,
the scoop arm includes a longitudinal channel, and
the leveling arm and the scoop arm are configured to couple together such that the longitudinal guide slides along the longitudinal channel.

12. The device of claim 11, wherein the longitudinal channel is configured to capture the longitudinal guide.

13. The device of claim 1, wherein the leveling arm includes a portion having a textured surface.

14. The device of claim 1, wherein the leveling arm is coupled to the scoop arm such that the leveling arm pivots about a point on the scoop arm.

15. The device of claim 14, wherein the substantially planar rim of the scoop is circular.

16. The device of claim 15, wherein the leveling bar is a semi-circular arc.

17. The device of claim 1, further comprising a handle disposed at a second end of the scoop arm, and a tamper disposed at an end of the handle opposite the scoop arm.

18. The device of claim 17, wherein the tamper has a transverse cross-section that is smaller than the transverse cross-section of the handle.

19. The device of claim 18, wherein the transverse cross-section of the tamper is round.

20. The device of claim 17, further comprising a guide pin disposed on an end of the tamper opposite the handle.

21. The device of claim 17, wherein the tamper has parallel sidewalls extending from the handle, and a closed end opposite the handle.

22. The device of claim 21, wherein the closed end has a face that is perpendicular to the sidewalls, and a portion that tapers from a periphery of the face to an end of the sidewalls.

23. The device of claim 21, wherein the tamper is cylindrical.

24. The device of claim 21, wherein the closed end is substantially flat.
